(19) United States
(12) Patent Application Publication
(10) Pub. No.: US 2026/0154556 A1
(43) Pub. Date: Jun. 4, 2026

(54) METHOD AND SYSTEM FOR FINE-TUNING LARGE LANGUAGE MODELS

(71) Applicant: L&T TECHNOLOGY SERVICES LIMITED, Chennai (IN)

(72) Inventors: SUDHIR BHADAURIA, Ahmedabad (IN); VIKRAM SUBRAMANI, Krishnagiri (IN)

(21) Appl. No.: 19/059,278

(22) Filed: Feb. 21, 2025

(30) Foreign Application Priority Data
Dec. 3, 2024 (IN) 202441095071

(51) Int. Cl. G06N 3/09; G06N 3/0475

(52) U.S. Cl. CPC G06N 3/09; G06N 3/0475

(57) ABSTRACT

A method and system of fine-tuning large language models is disclosed. The method includes receiving a user input corresponding to an LLM. The user input includes a selection of a set of target layers, predefined scoring criteria, and a distribution ratio. The method further includes determining a score corresponding to each of a plurality of weights of each of the set of target layers based on the predefined scoring criteria; for each of the set of target layers, classifying the plurality of weights into a set of trainable weights and a set of non-trainable weights based on the score and the distribution ratio; and for each of the set of target layers, modifying the set of trainable weights using a domain-specific training dataset to obtain a fine-tunned LLM.

### CROSS-REFERENCE TO RELATED APPLICATIONS

This application is a Non-Provisional Application, which claims priority to the Indian non-provisional patent application No. 202441095071, filed Dec. 3, 2024, entitled “METHOD AND SYSTEM FOR FINE-TUNING LARGE LANGUAGE MODELS”, which is hereby incorporated by reference in its entirety.

### DESCRIPTION

### Technical Field

This disclosure relates generally to fine-tuning, and more particularly to a method and system for fine-tuning Large Language Models (LLMs).

### BACKGROUND

Generally, LLMs include two types of modules-an attention module, and a multilayer perceptron module (MLP). However, because of the vast amount of training dataset there is a possibility that the LLMs may create redundancy in heads and less potent weights in the attention module, as some heads may capture similar information and some weights from less effective heads also leads to reduction in the model effectiveness. Further, the MLP layers may experience repetitions which may result in redundancy in weights and feature learning among deeper layers.

To resolve this problem, conventional methods like full fine-tuning and adapter-based fine-tuning are used. The full fine-tuning method tunes the model by training all parameters of the LLM, this may cause substantial computational resources and time. Further, in adapter-based fine-tuning the LLMs are introduced with additional layers or parameters that increase the complexity of the model.

Therefore, there is a requirement for a methodology to make LLMs efficient with respect to resources, computational power, speed, and deployment.

### SUMMARY OF THE INVENTION

In an embodiment, a method for fine-tuning large language model (LLM) is disclosed. The method may include receiving, by the processor, a user input corresponding to an LLM. The user input may include a selection of a set of target layers from a plurality of layers of the LLM, predefined scoring criteria, training dataset, and a distribution ratio. The method may further include determining, by the processor, a score corresponding to each of a plurality of weights of each of the set of target layers based on the predefined scoring criteria. In an embodiment, the plurality of weights may be associated with a corresponding plurality of neurons in a target layer. Further, the method may include, classifying for each of the set of target layers, by the processor, the plurality of weights into a set of trainable weights and a set of non-trainable weights based on the score of each of the plurality of weights and the distribution ratio. The method may further include modifying, for each of the set of target layers, by the processor the set of trainable weights using a domain-specific training dataset to obtain a fine tunned LLM.

In another embodiment, a system for fine-tuning large language model (LLMs) is disclosed. the system may include a processor, and a memory communicably coupled to the processor, wherein the memory may store processor-executable instructions, which when executed by the processor may cause the processor to receive a user input corresponding to an LLM. In an embodiment, the user input may include a selection of a set of target layers from a plurality of layers of the LLM, predefined scoring criteria, and a distribution ratio. Further the processor may determine a score corresponding to each of a plurality of weights of each of the set of target layers based on the predefined scoring criteria. In an embodiment, the plurality of weights may be associated with a corresponding plurality of neurons in a target layer. For each of the set of target layers, the processor may classify the plurality of weights into a set of trainable weights and a set of non-trainable weights based on the score of each of the plurality of weights and the distribution ratio. The processor may further modify, for each of the set of target layers, the set of trainable weights using a domain-specific training dataset to obtain a fine-tunned LLM.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 illustrates a block diagram of an exemplary system for fine-tuning large language models (LLMs), in accordance with some embodiments of the present disclosure.

FIG. 2 illustrates a functional block diagram of a fine-tuning device of FIG. 1, in accordance with some embodiments of the present disclosure.

FIG. 3 illustrates a flow diagram of an exemplary process for fine-tuning the large language models, in accordance with some embodiments of the present disclosure.

FIG. 4 illustrates a flow diagram of an exemplary process for classifying the plurality of weights into a set of trainable weights and a set of non-trainable weights, in accordance with some embodiments of the present disclosure.

FIG. 5 illustrates a flow diagram of an exemplary process for modifying the set of trainable weights, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

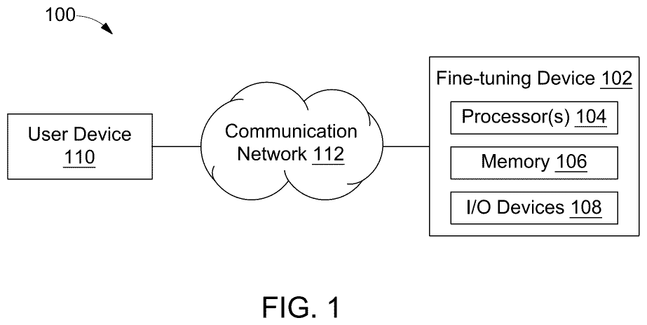

Referring now to FIG. 1, a block diagram of an exemplary system 100 for fine-tuning Large Language Models (LLMs) is illustrated, in accordance with some embodiments of the present disclosure. The system 100 may include a fine-tuning device 102. By way of an example, the fine-tuning device 102 may be a server, a desktop, a laptop, a notebook, a netbook, a tablet, a smartphone, a mobile phone, or any other computing device.

The fine-tuning device 102 may include a processor 104 and a memory 106. In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™, system on a chip processors or other future processors. The memory 106 may be communicatively coupled to the processor 104. In an embodiment, the memory 106 may store instructions that, when executed by the processor 104, may cause the processor 104 to fine-tune LLMs, as discussed in more details below. The memory 106 may may also store various data (for example, domain-specific training dataset, pre-trained LLM weights, predefined scoring criteria, and the like) that may be captured, processed, and/or required by the system 100. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM). Examples of volatile memory may include but are not limited to, Dynamic Random Access Memory (DRAM) and Static Random-Access Memory (SRAM).

In an embodiment, the fine-tuning device 102 may include I/O devices 108. Examples of the I/O devices may include, but are not limited to a display, keypad, microphone, audio speakers, vibrating motor, LED lights, etc. In such an embodiment, the I/O devices 108 may facilitate inputting of instructions by a user communicating with the fine-tuning device 102. In an embodiment, the I/O devices 108 may be wirelessly connected to the computing device 102 through wireless network interfaces such as Bluetooth®, infrared, or any other wireless radio communication known in the art. In an embodiment, the I/O devices 108 may be connected to a communication pathway for one or more components of the fine-tuning device 102 to facilitate the transmission of inputted instructions and output results of data generated by various components such as, but not limited to, processor(s) 104 and memory 106.

In another embodiment, the fine-tuning device 102 may be communicably coupled to a user device 110 through a communication network 112. The user device 110 may be, for example, but may not be limited to, a desktop, a laptop, a notebook, a netbook, a tablet, a smartphone, a mobile phone, or any other computing device. In such an embodiment, the fine-tuning device 102 may receive user inputs from the user device 110 over the communication network 112. Similarly, upon processing the user inputs, the fine-tuning device 102 may transmit the outputs to the user device 110 over the communication network 112. The communication network 112 may be a wired network, a wireless network, or a combination thereof. The communication network 112 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 112 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the communication network 112 can include a variety of network devices, including routers, bridges, servers, computing devices, storage devices, and the like.

Thus, the fine-tuning device 102 may interact directly with the user as a standalone device (via the embodiment where the fine-tuning device 102 includes the I/O device 108) or may interact with the user via the user device 110. When interacting directly with the user, the fine-tuning device 102 may be a standalone device and may render a User Interface (UI) via the I/O device 108. When interacting with the user through the user device 110, the fine-tuning device 102 may render the UI on the user device 110.

The fine-tuning device 102 may receive an LLM that is to be fine-tuned. Examples of the LLM may include, but are not limited to, zephyr, Large Language Model Meta AI (LLAMA), Generative Pre-trained Transformer (GPT), Gemini, Falcon LLM, BLOOM, etc. The LLM may be a pre-trained LLM or may be a fine-tuned LMM trained for a specific domain or a specific task. The LLM may include a plurality of layers. Each of the plurality of layers may correspond to a layer of one or more neurons. It should be noted that the term “plurality of neurons” is herein used interchangeably with “one or more neurons”.

Further, to initiate the fine-tuning of the LLM, the fine-tuning device 102 may receive a user input corresponding to the LLM. The user input may include a selection of a set of target layers from a plurality of layers of the LLM, predefined scoring criteria for scoring weights in a layer, and a distribution ratio of trainable weights and non-trainable weights in a layer. The user input may be received from a user through at least one of the I/O device 108 or the user device 110 over the communication network 112. Each input of the user input may be received together (i.e., via a single command or through a single data submission), or may be received individually when prompted to the user via the UI.

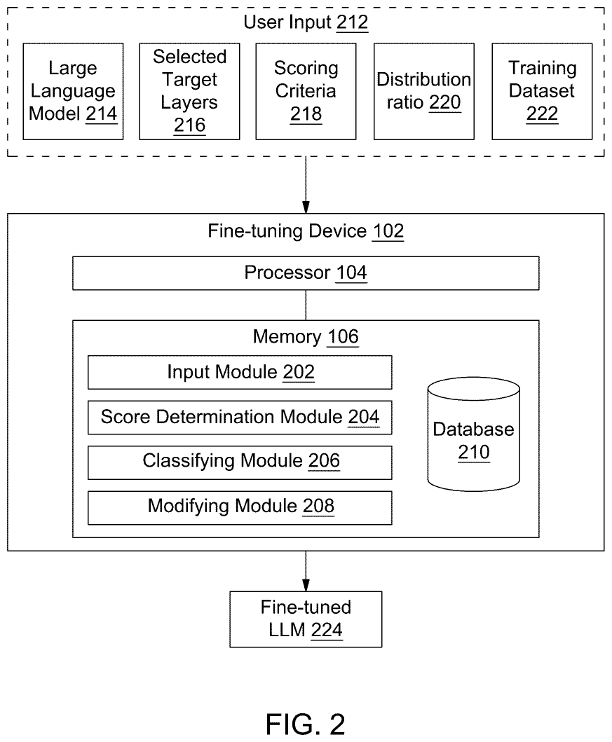

The set of target layers may include the layers of the LLM selected by the user for domain-specific fine-tuning of the LLM. Each of the set of target layers may be one of an independent layer or a group of interdependent layers. In other words, if a selected target layer is dependent on one or more other layers, or if one or more other layers are dependent on the selected target layer, each of such interdependent layers may be grouped and processed as a single unit or a single target layer. This is explained in greater detail in conjunction with FIG. 2.

Further, the fine-tuning device 102 may determine a score corresponding to each of the plurality of weights of each of the set of target layers based on the pre-defined scoring criteria. The plurality of weights may be associated with a corresponding plurality of neurons in a target layer. That is to say, the fine-tuning device 102 may freeze the plurality of weights in remaining of the plurality of layers. In some embodiments, the pre-defined scoring criteria may be based on at least one of a weight importance, a distance-based weight redundancy, or a similarity-based weight redundancy. This is explained in greater detail in conjunction with FIG. 2.

In an embodiment, the fine-tuning device 102 may determine the score based on the similarity-based weight redundancy that may include, for each of the weight of the plurality of weights in each of the set of target layers, calculate the score based on a similarity of weight with each of remaining of the plurality of weights. In an embodiment, when a target layer is a group of interdependent layers, the score may be a sum of similarity scores of each of the group of interdependent layers. The similarity-based weight redundancy may be achieved by measuring the distance between two data points or weights of the plurality of weights and calculating the shortest distance using Pythagorean theorem. Further, determining the score includes assigning the score to each of the plurality of weights based on the similarity.

Further, for each of the set of target layers, the fine-tuning device 102 may classify the plurality of weights into a set of trainable weights and a set of non-trainable weights from the plurality of weights based on the determined score and the distribution ratio. The distribution ratio may correspond to a user-defined ratio of trainable weights to non-trainable weights for the plurality of weights in each of the set of target layers. In an embodiment, the distribution ratio may be based on requirements such as model requirements, task complexity, and fine-tuning requirements. These requirements are addressed by the user and hence, the distribution ratio may be user-defined. To classify the plurality of weights, the fine-tuning device 102 may determine a number of weights for selection from the plurality of weights based on the distribution ratio. Further, based on the score of each of the plurality of weights the fine-tuning device 102 may classify a first set of weights including the determined number of weights as the set of trainable weights. The fine-tuning device 102 may classify a second set of weights including remaining of the plurality of weights as the set of non-trainable weights.

Further, the fine-tuning device 102 may modify the set of trainable weight for each of the set of target layers using a domain-specific training dataset to obtain a fine-tuned LLM. The fine-tuning device 102 may receive the domain-specific training dataset as a user input. In an embodiment, the domain-specific training dataset may include labelled data corresponding to a domain. The domain may be a field of interest for which the user may want to train the LLM to provide domain-specific responses to queries and/or to execute domain-specific tasks for the user. To modify the set of trainable weights, for each of the set of target layers, the fine-tuning device 102 may define each of the set of non-trainable weights as non-changeable. Further, for each of a plurality of iterations of epochs (i.e., training cycles), the fine-tuning device 102 may update the set of trainable weights in each of the set of target layers, based on the domain-specific training dataset to obtain the fine-tuned LLM. The fine-tuned LLM may as obtained, may be configured to perform task-specific or domain-specific operations based on the user queries. It should be noted that each layer of the fine-tuned LLM may utilize the set of non-trainable weights to preserve pre-existing (or in some cases, generic) knowledge and may utilize the set of trainable weights to implement domain-specific knowledge.

Referring now to FIG. 2, a functional block diagram of a fine-tuning device 102 is illustrated, in accordance with some embodiments of the present disclosure. FIG. 2 is explained in conjunction with FIG. 1. The memory 106 of the fine-tuning device 102 may include an input module 202, a score determination module 204, a classifying module 206, a modifying module 208, and a database 210.

Initially, the input module 202 may receive a user input 212. The user input 212 may include an LLM 214, a selection of target layers 216, a predefined scoring criteria 218, and a distribution ratio 220. Each of the selection of target layers 216, the predefined scoring criteria 218, and the distribution ratio 220 may correspond to the LLM 214. Each input of the user input 212 may be received together as a common submission (i.e., via a single command or through a single data submission), or may be received individually at an appropriate stage when prompted to the user via the UI. The user input 212 may be received from the user device 110 through the communication network 112 or directly via the I/O device 108 based on configuration of the system 100. This has already been discussed in detail in conjunction with FIG. 1.

Upon receiving the LLM 214, the input module 202 may store the LLM 214 in the database 210. Examples of the LLM may include, but are not limited to, zephyr, Large Language Model Meta AI (LLAMA), Generative Pre-trained Transformer (GPT), Gemini, Falcon LLM, BLOOM, etc. In an embodiment, the LLM 214 may include a decoder block (or a decoder layer). The decoder block may include an attention module and an MLP module. An exemplary LLAMA2 LLM architecture including the said decoder block is shown below:
LlamaForCausalLM(
   (model): LlamaModel(
      (embed_tokens): Embedding(32000, 4096)
      (layers): ModuleList(
#Decoder Block of the LLM
   (0-31): 32 x LlamaDecoderLayer(
#Attention module of the LLM
   (self_attn): LlamaAttention(
   (q_proj): Linear(in_features=4096, out_features=4096, bias=False)
   (k proj): Linear(in_features=4096, out_features=4096, bias=False)
   (v_proj): Linear(in_features=4096, out_features=4096, bias=False)
   (o_proj): Linear(in_features=4096, out_features 4096, bias=False)
   (rotary_emb): LlamaRotaryEmbedding( )
   )
#End of Attention module
#MLP module of the LLM
   (mlp): LlamaMLP(
   (gate_proj): Linear(in_features=4096, out_features=11008, bias=False)
   (up_proj): Linear(in_features=4096, out_features=11008, bias=False)
   (down_proj): Linear(in_features=11008, out_features=4096, bias=False)
   (act_fn): SiLUActivation( )
   )
#End of MLP module
   (input_layernorm): LlamaRMSLrm( )
   (post_attention_layernorm): LlamaRMSNorm( )
   )
   )
   (norm): LlamaRMSNorm( )
   )
   (lm_head): Linear(in_features=4096, out_features=32000, bias=False)
)

Further, the input module 202 may receive a selection of a set of target layers 216 from the plurality of layers of the LLM 214. It should be noted that the fine-tuning of the LLM 214 may not be performed on remaining of the plurality of layers (i.e., plurality of layers apart from the set of target layers). Each of the set of target layers 216 may be an individual layer or a group of interdependent layers. In an embodiment, the selection of the set of target layers may be done based on an analysis of interdependency of plurality of layers of the LLM 214.

Further, the input module 202 may receive the predefined scoring criteria 218. The predefined scoring criteria 218 input by user may refer to a criteria to identify redundant weights, less significant weights, or less effective weights. The score determination module 204 may determine a score corresponding to each of a plurality of weights of each of the set of target layers based on the predefined scoring criteria 218. The plurality of weights may be associated with a corresponding plurality of neurons in a target layer. These weights may have numerical values that represent the strength of connections between neurons in the LLM 214.

The predefined scoring criteria 218 may be based on at least one of a weight importance, a distance-based weight redundancy, or a similarity-based weight redundancy. When the predefined scoring criteria 218 is based on the weight importance, the score determination module 204 may determine a magnitude of each of the plurality of weights of each of the set of target layers. In an embodiment, when a target layer is a group of interdependent layers, the magnitude may be a sum of magnitudes of each of the group of interdependent layers. The magnitude of each of the plurality of weights refers to a numerical value or size of each of the plurality of weights or any other value derived from such numerical values (e.g., mean, median, geometric median, or the like). In other words, the weight importance may be correlated to the numerical value associated with the weight. For example, a weight value of 0.8 may be more important (and may thus, have a higher score) than a weight value of 0.3. In an embodiment, when the target layer is a group of interdependent layers, then the magnitude may be a sum of magnitudes of each of the group of interdependent layers. For example, a group of interdependent layers with a high magnitude (i.e., sum of magnitudes of each of the group of interdependent layers) may correspond to a higher score. Further, the score determination module 204 may assign the score to each of the plurality of weights based on the magnitude.

In an embodiment when the pre-defined scoring criteria is based on the distance-based weight redundancy, the score determination module 204 may determine the score by determining a distance of the plurality of weights of each of the set of target layers. In an embodiment, the distance may include, but may not be limited to, Euclidean distance, cosine distance, etc. In an embodiment, when the target layer is a group of interdependent layers, the distance may be a distance of the plurality of weights of each of the group of interdependent layers. Further, the score determination module 204 may assign the score to each of the plurality of weights based on the distance.

In an embodiment, when the predefined scoring criteria 218 is based on the similarity-based weight redundancy, for each of the plurality of weights in each of the set of target layers, the score determination module 204 may calculate the score based on similarity of the weight with each of remaining of the plurality of weights. In an embodiment, when the target layers may be a group of interdependent layers, the score may be a sum of similarity scores of each of the interdependent layers. In an embodiment, the similarity-based weight redundancy determination techniques may include, but may not be limited to cosine similarity, Euclidean similarity, or another measure of proximity amongst the plurality of weights. In similarity-based weight redundancy determination, the score determination module 204 may evaluate each of the plurality of weights based on the similarity to remaining of the plurality of weights in each of the set of target layers. The similarity may be determined by computing a geometric median of the plurality of weights in each of the set of target layers. Based on the similarity, a score (for example, a numerical value) may be assigned by the score determination module 204 to each of the plurality of weights. The score may be indicative of how similar the corresponding weight is to remaining of the plurality of weights in each of the set of target layers.

By way of an example, the attention module may include a query projection layer, a key projection layer, and a value projection layer. The query projection, key projection, and value projection layers may include interdependent layers. The query projection, key projection, and value layers may each have 4096 input neurons and 4096 output neurons. The plurality of weights in each of the query projection, key projection, and value projection layers may be divided into 32 groups, corresponding to the 32 attention heads in the multi-head attention mechanism. The first 128 output neurons from each layer are assigned to the first group, and so on. Thus, 32 groups of interdependent layers may be obtained. A predefined scoring criterion, such as cosine distance, is applied to the weights within each group, and the resulting distances are summed to compute a score for each group. This score helps to identify redundant/less important weights associated with specific attention heads. Thus, a score is calculated for each group (i.e., each group of weights).

The attention module may further include an output projection layer. The output projection layer may have 4096 input neurons and 4096 output neurons. The output projection layer operates independently (i.e., an independent layer) to produce a feature map. A criterion, such as cosine distance, is applied to the weights of the 4096 output neurons to detect redundant or less important neurons. Thus, a score is calculated for each neuron (i.e., each weight).

The MLP module may include a gate projection layer and an up projection layer. The gate projection layer and the up projection layer may each have 4096 input neurons and 11,008 output neurons. The plurality of weights in the gate projection and the up projection layers may be divided into 11,008 groups, where the first neuron from each layer forms the first group, and so on (i.e., one neuron from each layer per group). A predefined scoring criterion, such as cosine distance, is applied to the weights within each group, and the resulting distances are summed to compute a score for each group.

The down projection layer may have 11008 input and 4096 output neurons. The down projection layer operates independently (i.e., an independent layer) to produce a feature map. A criterion, such as cosine distance, is applied to the weights of the 4096 output neurons to detect redundant or less important neurons. A group of weights corresponds to each neuron. Each neuron has 11008 weights as there are 11008 input neurons.

Further, the classifying module 206 may classify the plurality of weights for each of the set of target layers, into a set of trainable weights and a set of non-trainable weights based on the score of each of the plurality of weights and the distribution ratio 220. that the distribution ratio 220 may depict a ratio of the set of trainable weights over the set of non-trainable weights from the plurality of weights in each of the set of target layers 216. In other words, the distribution ratio 220 corresponds to a user-defined ratio of trainable weights to non-trainable weights for the plurality of weights in each of the set of target layers 216. The distribution ratio may be user-defined and may depend on the score of each weight, LLM requirements for updating a certain proportion of the trainable weights, and/or computational capacity available. This requirement may be dependent on the domain-specific task to be performed by the LLM 214, as well as the precision and accuracy standards expected from the LLM 214.

To classify the plurality of weights in each of the set of target layers, the classifying module 206 may determine a number of weights for selection from the plurality of weights based on the distribution ratio 220. Further, based on the determined score of each of the plurality of weights, the classifying module 206 may classify the first set of weights including the determined number of weights as the set of trainable weights. Further, the classifying module 206 may classify a second set of weights including remaining of the plurality of the weights as the set of non-trainable weights. By way of an example, the distribution ratio is 80% and a target layer includes 100 weights. Then, the classifying module 206 may classify first 80 weights from the 100 weights in a descending order of the score as the set of trainable weights. The classifying module 206 may classify the remaining 20 weights (or last 20 weights from the 100 weights in a descending order of the score) as the set of non-trainable weights.

Further, the modifying module 208 may modify the set of trainable weights for each of the set of target layers 216, using a domain-specific training dataset 222 to obtain a fine-tuned LLM 224. The domain-specific training dataset may include labelled data corresponding to a domain (for example, medical domain, finance domain, IT domain, etc.). In an embodiment, the domain-specific training dataset may include business-specific data. The domain-specific training dataset may include, but may not be limited, to a medical domain-specific dataset, finance domain-specific dataset, employer-related dataset, customer relations-specific dataset, etc. The task performed by the LLM may include, but may not be limited to data interpretation, face recognition, detection and classification of data, etc.

To modify the set of trainable weights using the domain-specific training dataset, for each of the set of target layers, the modifying module 208 may define each of the set of non-trainable weights as non-changeable. In other words, the modifying module 208 may freeze each of the set of non-trainable weights. Further, modifying module 208 may provide the domain-specific training dataset as an input to the LLM 214. Further, for each of a plurality of iterations of epochs, the modifying module 208 may update the set of trainable weights in each of the set of target layers based on the domain-specific training dataset to obtain the fine-tuned LLM.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for fine-tuning LLMs. For example, the exemplary system 100 and the associated fine-tuning device 102 may fine-tune LLMs by the processes discussed herein. In particular, as will be appreciated by those of ordinary skill in the art, control logic and/or automated routines for performing the techniques and steps described herein may be implemented by the system 100 and the associated fine-tuning device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

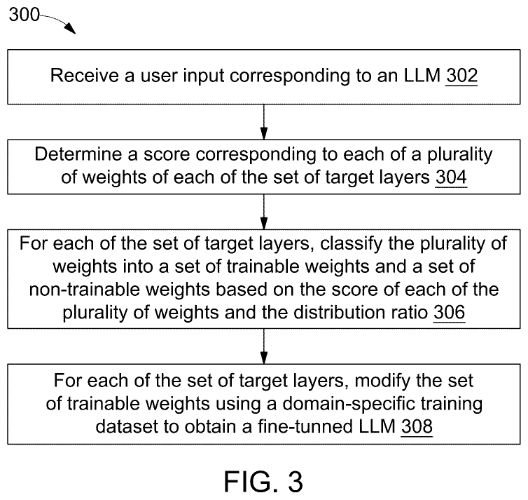

Referring to FIG. 3, an exemplary process for fine-tuning LLMs is depicted via a flowchart, in accordance with some embodiments of the present disclosure is disclosed. FIG. 3 is explained in conjunction with FIGS. 1 and 2. In an embodiment, the process 300 may include a plurality of steps that may be performed by the processor 104 via the modules 202-208 of the fine-tuning device 102.

At step 302, the input module 202 may receive a user input corresponding to an LLM 214. The user input may include a selection of a set of target layers 216 from a plurality of layers of the LLM 214, predefined scoring criteria 218, and a distribution ratio 220. In an embodiment, each of the set of target layers may be one of an independent layer or a group of interdependent layers.

At step 304, the score determination module 204 may determine a score corresponding to each of a plurality of weight of each of the set of target layer based on the predefined scoring criteria 218. It should be noted that the plurality of weights may be associated with a corresponding plurality of neurons in the target layer. In an embodiment, the predefined scoring criteria 218 may be based on at least one of a weight importance, a distance-based weight redundancy, or a similarity-based weight redundancy.

In an embodiment when the predefined scoring criteria 218 is based on the weight importance, the process 300 may include determining, by the score determination module 204, a magnitude of each if the plurality of weights of each of the set of target layers. In an embodiment, when a target layer is may be a group of interdependent layers, the magnitude may be a sum of magnitudes of each of the group of interdependent layers. Further, the process 300 may include assigning, by the score determination module 204, the score to each of the plurality of weights based on the magnitude. It should be noted that weights with lower magnitudes may be considered less important compared to weights with higher magnitudes.

In an embodiment when the predefined scoring criteria 218 is based on the distance-based weight redundancy, the process 300 may include determining, by the score determination module 204, a distance of the plurality of weights of each of the set of target layers. In an embodiment, the target layers may be a group of interdependent layers, the distance may be a distance of the plurality of weights of each of the group of interdependent layers. Further, the process 300 may include assigning, by the score determination module 204, the score to each of the plurality of weights based on the distance. In an embodiment, the distance between the plurality of the weights may be calculated based on a distance metric such as, but not limited to, the cosine distance method, and Euclidean distance method. It should be noted that weights that are highly similar or close in distance to others may be considered redundant. In an embodiment when the predefined scoring criteria 218 is based on the similarity-based weight redundancy, the process 300 may include, for each of the plurality of weights in each of the set or target layers, calculating, by the score determination module 204, the score based on a similarity of the weight with each of remaining of the plurality of weights. In an embodiment, the similarity may be calculated through geometric median of the plurality of weights. Weights that are close to the geometric median may be redundant, as they are similar to the majority of the plurality of weights. Further, for each of the set of target layers, the process 300 may include identifying, by the score determination module 204, the set of trainable weights and the set of non-trainable weights from the plurality of weights based on the score.

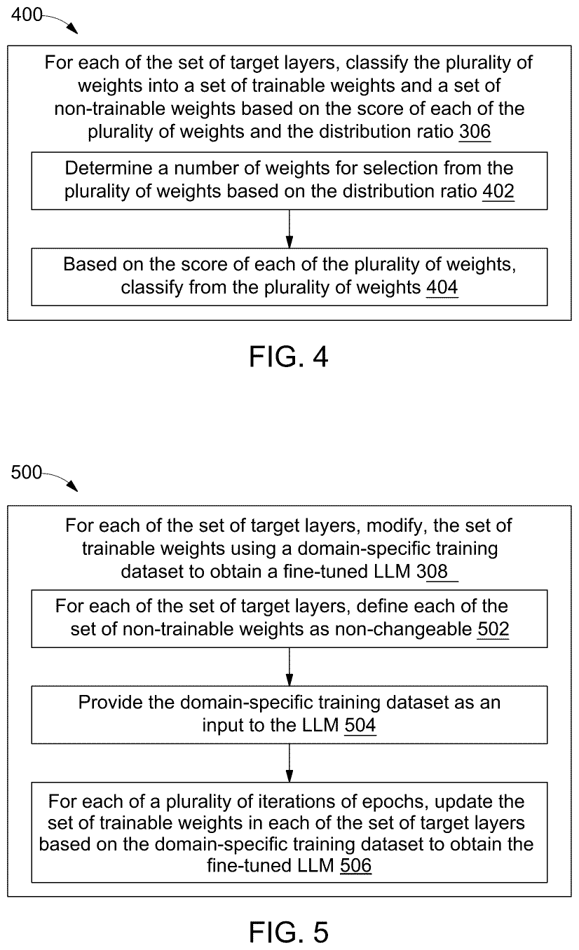

Further at step 306, for each of the set of target layers, the process 300 may include classifying, by the classifying module 206, the plurality of weights into a set of trainable weights and a set of non-trainable weights based on the score of each of the plurality of weights and the distribution ratio. In an embodiment, the distribution ratio may correspond to a user-defined ratio of trainable weights to non-trainable weights for the plurality of weights in each of the set of target layers. This is further explained in greater detail in conjunction with FIG. 4. At step 308, for each of the set of target layers the process 300 may include modifying, by the modifying module 208, the set of trainable weights using a domain-specific training dataset to obtain a fine-tunned LLM. This is further explained in greater detail in conjunction with FIG. 5. Further the fine-tuned LLM may be used for different task based on the training of the LLM performed using domain-specific training dataset. Such tasks may be user-specific or domain-specific, for example, verification of the data, face recognition, etc.

Referring now to FIG. 4, an exemplary process 400 for classifying the plurality of weights into a set of trainable weights and a set of non-trainable weights is depicted via a flowchart, in accordance with some embodiments of the present disclosure is disclosed. FIG. 4 is explained in conjunction with FIGS. 1-3. The process 400 may be implemented by the fine-tuning device 102 of the system 100. The process 400 may include classifying, by the classifying module 206, the plurality of weights into the set of trainable weights and the set of non-trainable weights for each of the set of target layers, based on the score of each of the plurality of weights and the distribution ratio, at step 306. Further, at step 402, the process 400 may include determining, by the classifying module 206, a number of weights for selection from the plurality of weights based on the distribution ratio. In an embodiment, the distribution ratio corresponds to a user-defined ratio of trainable weights to non-trainable weights for the plurality of weights in each of the set of target layers.

At step 404, the process 400 may include, based on the score of each of the plurality of weights, classifying, by the classifying module, from the plurality of weights, a first set of weights including the determined number of weights as the set of trainable weights, and a second set of weights including remaining of the plurality of weights as the set of non-trainable weights.

Referring now to FIG. 5, a an exemplary process 500 for modifying the set of trainable weights is depicted via a flowchart, in accordance with some embodiments of the present disclosure. FIG. 5 is explained in conjunction with FIGS. 1-4. The process 500 may be implemented by the fine-tuning device 102 of the system 100. The process 500 may include, for each of the set of target layers, modifying, by the modifying module 208, the set of trainable weights using a domain-specific training dataset to obtain the fine-tuned LLM, at step 308. In an embodiment, the domain-specific training dataset may include, but may not be limited to, medical training dataset, legal domain dataset, financial dataset, and scientific research related dataset. At step 502, for each of the set of target layers, the process 500 may include defining, by the modifying module 208, each of the set of non-trainable weights as non-changeable. Further, at step 504, the process 500 may include providing, by the modifying module 208, the domain-specific training dataset as an input to the LLM. In an embodiment, the domain-specific training dataset may include labelled data corresponding to a domain. Further, at step 506, for each of the plurality of iterations of epochs, the process 500 may include updating, by the modifying module 208, the set of trainable weights in each of the set of target layers based on the domain-specific training dataset to obtain the fine-tuned LLM. In the embodiment, the modifying module 208 may iteratively fine-tune the trainable weights until a desired fine-tuned LLM may be achieved.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

As will be appreciated by those skilled in the art, the techniques described in the various embodiments discussed above are not routine, or conventional, or well-understood in the art. The techniques discussed above provide for fine-tuning the large language models.

Based on the above described methods the LLM may overcome the issue of redundant or less potential multiheaded attention that allows models to focus on various parts of the input sequence simultaneously. Further, it also reduces the redundancy in heads in which some heads may capture similar information, leading to redundancy, also called over-parameterization.

The above mentioned methods may also reduce the redundancy in MLP weights in which large number of neurons and weights may result in some being less impactful.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described the method and system for fine-tuning the large language models. The illustrated steps are set out to explain the exemplary embodiments shown, and it should be anticipated that ongoing technological development will change the manner in which particular functions are performed. These examples are presented herein for the purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A method for fine-tuning large language model (LLM), comprising:
receiving, by a processor, a user input corresponding to an LLM, wherein the user input comprises a selection of a set of target layers from a plurality of layers of the LLM, predefined scoring criteria, and a distribution ratio;
determining, by the processor, a score corresponding to each of a plurality of weights of each of the set of target layers based on the predefined scoring criteria, wherein the plurality of weights is associated with a corresponding plurality of neurons in a target layer;
for each of the set of target layers, classifying, by the processor, the plurality of weights into a set of trainable weights and a set of non-trainable weights based on the score of each of the plurality of weights and the distribution ratio; and
for each of the set of target layers, modifying, by the processor, the set of trainable weights using a domain-specific training dataset to obtain a fine-tunned LLM.

2. The method of claim 1, wherein each of the set of target layers is one of an independent layer or a group of interdependent layers.

3. The method of claim 1, wherein the predefined scoring criteria is based on at least one of a weight importance, a distance-based weight redundancy, or a similarity-based weight redundancy.

4. The method of claim 3, wherein determining the score based on the weight importance comprises:
determining, by the processor, a magnitude of each of the plurality of weights of each of the set of target layers, wherein when a target layer is a group of interdependent layers, the magnitude is a sum of magnitudes of each of the group of interdependent layers; and
assigning, by the processor, the score to each of the plurality of weights based on the magnitude.

5. The method of claim 3, wherein determining the score based on the distance-based weight redundancy comprises:
determining, by the processor, a distance of the plurality of weights of each of the set of target layers, wherein when a target layer is a group of interdependent layers, the distance is a distance of the plurality of weights of each of the group of interdependent layers; and
assigning, by the processor, the score to each of the plurality of weights based on the distance.

6. The method of claim 3, wherein determining the score based on the similarity-based weight redundancy comprises:
for each of the plurality of weights in each of the set of target layers, calculating, by the processor, the score based on a similarity of the weight with each of remaining of the plurality of weights, wherein when a target layer is a group of interdependent layers, the score is a sum of similarity scores of each of the group of interdependent layers; and
for each of the set of target layers, identifying, by the processor, the set of trainable weights and the set of non-trainable weights from the plurality of weights based on the score.

7. The method of claim 1, wherein classifying the plurality of weights comprises:
determining, by the processor, a number of weights for selection from the plurality of weights based on the distribution ratio, wherein the distribution ratio corresponds to a user-defined ratio of trainable weights to non-trainable weights for the plurality of weights in each of the set of target layers; and
based on the score of each of the plurality of weights, classifying, by the processor, from the plurality of weights:
a first set of weights comprising the determined number of weights as the set of trainable weights, and
a second set of weights comprising remaining of the plurality of weights as the set of non-trainable weights.

8. The method of claim 1, wherein modifying the set of trainable weights using the domain-specific training dataset comprises:
for each of the set of target layers, defining, by the processor, each of the set of non-trainable weights as non-changeable;
providing, by the processor, the domain-specific training dataset as an input to the LLM, wherein the domain-specific training dataset comprises labelled data corresponding to a domain; and
for each of a plurality of iterations of epochs, updating, by the processor (104), the set of trainable weights in each of the set of target layers based on the domain-specific training dataset to obtain the fine-tuned LLM.

9. A system for fine-tuning large language model (LLMs), comprising:
a processor;
a memory communicably coupled to the processor, wherein the memory stores processor-executable instructions, which, on execution, cause the processor to:
receive a user input corresponding to an LLM, wherein the user input comprises a selection of a set of target layers from a plurality of layers of the LLM, predefined scoring criteria, and a distribution ratio;
determine a score corresponding to each of a plurality of weights of each of the set of target layers based on the predefined scoring criteria, wherein the plurality of weights is associated with a corresponding plurality of neurons in a target layer;
for each of the set of target layers, classify the plurality of weights into a set of trainable weights and a set of non-trainable weights based on the score of each of the plurality of weights and the distribution ratio; and
for each of the set of target layers, modify the set of trainable weights using a domain-specific training dataset to obtain a fine-tunned LLM.

10. The system of claim 9, wherein each of the set of target layers is one of an independent layer or a group of interdependent layers.

11. The system of claim 9, wherein the predefined scoring criteria is based on at least one of a weight importance, a distance-based weight redundancy, or a similarity-based weight redundancy.

12. The system of claim 11, wherein to determine the score based on the weight importance, the processor is configured to:
determine a magnitude of each of the plurality of weights of each of the set of target layers, wherein when a target layer is a group of interdependent layers, the magnitude is a sum of magnitudes of each of the group of interdependent layers; and
assign the score to each of the plurality of weights based on the magnitude.

13. The system of claim 11, wherein to determine the score based on the distance-based weight redundancy, the processor is configured to:
determine a distance of the plurality of weights of each of the set of target layers, wherein when a target layer is a group of interdependent layers, the distance is a distance of the plurality of weights of each of the group of interdependent layers; and
assign the score to each of the plurality of weights based on the distance.

14. The system of claim 11, wherein to determine the score based on the similarity-based weight redundancy, the processor is configured to:
for each weight of the plurality of weights in each of the set of target layers, calculate the score based on a similarity of the weight with each of remaining of the plurality of weights, wherein when a target layer is a group of interdependent layers, the score is a sum of similarity scores of each of the group of interdependent layers; and
for each of the set of target layers, identify the set of trainable weights and the set of non-trainable weights from the plurality of weights based on the score.

15. The system of claim 9, wherein to classify the plurality of weights, the processor is configured to:
determining, by the processor, a number of weights for selection from the plurality of weights based on the distribution ratio, wherein the distribution ratio corresponds to a user-defined ratio of trainable weights to non-trainable weights for the plurality of weights in each of the set of target layers; and
based on the score of each of the plurality of weights, classifying, by the processor, from the plurality of weights:
a first set of weights comprising the determined number of weights as the set of trainable weights, and
a second set of weights comprising remaining of the plurality of weights as the set of non-trainable weights.

16. The system of claim 9, wherein to modify the set of trainable weights using the domain-specific training dataset, the processor is configured to:
for each of the set of target layers, defining, by the processor, each of the set of non-trainable weights as non-changeable;
providing, by the processor, the domain-specific training dataset as an input to the LLM, wherein the domain-specific training dataset comprises labelled data corresponding to a domain; and
for each of a plurality of iterations of epochs, updating, by the processor (104), the set of trainable weights in each of the set of target layers based on the domain-specific training dataset to obtain the fine-tuned LLM.
